(19) United States
(12) Patent Application Publication
(10) Pub. No.: US 2005/0012794 A1
(43) Pub. Date: Jan. 20, 2005

(54) Refillable ink cartridge for an inkjet printer

(76) Inventor: Tat Kong Chau, Hong Kong (HK)

Correspondence Address: KAPLAN & GILMAN , L.L.P., 900 ROUTE 9 NORTH, WOODBRIDGE, NJ, 07095, US

(21) Appl. No.: 10/622,604

(22) Filed: Jul. 18, 2003

(51) Int. Cl. B41J 2/175

(52) U.S. Cl. 347/86

(57) ABSTRACT

A refillable ink cartridge for removable connection to a print head of an inkjet printer. The ink cartridge comprises at least one ink chamber comprising side walls and a bottom wall. A cover hermetically seals the ink chamber or chambers by forming a top wall therefor. Each ink chamber has a tube associated with it, the tube extending from the cover into the ink chamber and comprising a continuous opening extending from an upper to a lower end of the tube. The opening at the lower end of the tube is associated with a valve to enable the opening to be opened and closed to controllably admit air into the ink chamber. The ink cartridge further comprises an ink supply port through which ink is supplied to the print head via an ink supply needle.

### FIELD OF INVENTION

The present invention relates generally to inkjet printers, and more particularly to ink cartridges for use in inkjet printers.

### BACKGROUND OF THE INVENTION

Ink jet printers print images by depositing droplets of ink onto a print medium in a desired pattern through a print head. Such printers typically include an ink cartridge which includes an ink chamber to serve as a reservoir for the storage of ink and to provide a means of supplying the ink to a print head. In a coloured inkjet printer, the ink cartridge may comprise a number of ink chambers, each of which holds a different colour ink.

Inkjet printers may use a variety of inkjet technologies to eject ink from a print head. The most commonly used technologies are thermal bubble and piezoelectric. In a print head for a thermal bubble printer, tiny resistors create heat to vaporize ink creating a bubble. By selectively energising resistors as the print head travels across the print medium the ink is disposed on the print medium in a desired pattern or image. In a print head for a piezoelectric inkjet printer, an electrical charge is applied to a piezo crystal located in the back of an ink chamber causing the crystals to vibrate creating a pressure wave which causes ink to be discharged from the print head.

FIG. 1 in the attached drawings illustrates a conventional ink cartridge 1 removably connected to a print head 2. The ink cartridge 1 has a plug 3 arranged in an ink supply port 4. The print head 2 has an ink supply needle 5 which passes through an aperture 6 in the plug 3 to allow ink 7 to flow from the ink chamber 8 to the print head 2. Once depleted of ink 7, the ink cartridge 1 may be disengaged from the print head 2 by withdrawing the ink supply needle 5 from the plug 3. This arrangement allows the ink cartridge 1 to be replaced or temporarily removed for refill without replacing the print head 2.

There is however, no simple mechanism available to prevent the ink leaking from the ink chamber whilst the print head is idle. Some ink cartridges attempt to overcome this problem by supplying the ink from the ink cartridge to the print head at negative pressure; that is, the pressure within the ink chamber is lower than the ambient pressure surrounding the ink supply port. This approach requires the negative pressure inside the ink chamber to be maintained within an operational range. Within the operational range, the ink forms a liquid seal within the ink supply port due to the surface tension of the ink thereby preventing the flow of ink. Therefore, the negative pressure must be sufficiently high to allow the ink to form the liquid seal and prevent the ink from flowing freely through the ink supply port and yet sufficiently low to allow an ink supply needle which supplies ink to the print head, to overcome the negative pressure to discharge the ink via an ink supply needle by capillary action.

As ink is discharged, the negative pressure within the ink chamber decreases making it increasingly difficult for ink to be supplied to the print head. In order to overcome this problem, many typical prior art ink cartridges include a vent hole in the upper wall of the ink chamber to permit the entry of ambient air to replace discharged ink in an attempt to equalize the pressure. However, an uncontrolled rush of ambient air into the ink chamber will cause the negative pressure within the ink chamber to increase significantly resulting in rupture of the liquid seal within the ink supply port thereby allowing the ink to flow freely out of the ink chamber.

Many prior art ink cartridges have addressed the problem of regulating the negative pressure within the ink cartridge by arranging a porous ink holding member such as a piece of foam within the ink chamber. The foam abuts the outlet providing a capillary force which creates negative pressure in the ink supply port to prevent ink from leaking from the ink cartridge.

However, prior art ink cartridges containing foam have a number of inherent disadvantages. The use of an ink holding member within the ink chamber causes wastage of ink since residual ink will remain in the ink holding member even when the ink levels are low. Furthermore, this results in the ink chamber having to be larger to compensate for the proportion of ink which will not be useable due to absorption by the ink holding member. The ink holding member may potentially contain grit or particles which may contaminate the ink or cause clogging of the ink supply needle. Furthermore, the presence of the ink holding member complicates and may increase the cost of refilling of the ink cartridge in the event that the ink cartridge is to be reused.

### SUMMARY OF THE INVENTION

It is an object of the present invention to provide an ink cartridge which ameliorates or overcomes some of the problems of the prior art.

According to a first embodiment of the present invention there is provided a refillable ink cartridge for removable connection to a print head. The ink cartridge comprises at least one ink chamber comprising side walls and a bottom wall. A cover hermetically seals the ink chamber or chambers by forming a top wall therefor. Each ink chamber has a tube associated with it, the tube extending from the cover into the ink chamber and comprising a continuous opening extending from an upper to a lower end of the tube. The opening at the lower end of the tube is associated with a valve to enable the opening to be opened and closed to controllably admit air into the ink chamber. The ink cartridge further comprises an ink supply port through which ink is supplied to the print head via an ink supply needle.

According to a second embodiment of the present invention there is provided a refillable ink cartridge for removable connection to a print head via an ink supply needle. The ink cartridge comprises at least one ink chamber with a cover hermetically sealing the ink chamber or chambers. The ink cartridge further includes an ink supply port having an aperture for receiving the ink supply needle and a stopper for the ink supply port. When the ink supply needle is inserted through the aperture in the ink supply port, the stopper is moved away from the aperture, thereby opening the ink supply port and when the ink supply needle is withdrawn from the aperture the stopper covers the aperture, thereby closing the ink supply port.

According to a third embodiment of the invention there is provided a method of assembling a refillable ink cartridge, the ink cartridge including an ink chamber having side walls and a bottom wall which includes an ink supply port. The method comprises welding a filter to an upper portion of the ink supply port and installing a stopper in the ink supply port. The ink supply port is sealed with a deformable film. A flexible film is attached to a portion of the lower opening of a tube, the tube extending into the ink chamber from a cover forming a top wall of the ink chamber. The ink injection port positioned within the cover is sealed with a resilient plug. The cover is welded to the ink chamber to form the top wall. Tape is adhered to an external surface of the cover to seal apertures therein. The ink chamber is evacuated via a needle inserted through the plug sealing the ink injection port and ink is suppled to the ink chamber via a needle inserted through plug in the ink injection port.

It is therefore an advantage of the present invention that the ink cartridge provided may be readily refilled with ink for reuse.

It is another advantage that the installation of an ink holding member within the ink cartridge is not required to maintain an operational negative pressure within the ink chamber. Furthermore, avoiding the use of an ink holding member within the ink chamber enhances efficiency, less ink is lost through absorption by the ink holding member.

It is yet another advantage that manufacture of the ink cartridge of the present invention is simpler and less costly to assemble than many prior art ink cartridges.

### BRIEF DESCRIPTION OF THE DRAWINGS

The present invention can be more fully understood by reading the subsequent detailed description and examples with reference made to the accompanying drawings in which:

FIG. 1 is a diagram of a prior art arrangement providing for removable connection of the ink cartridge to the print head.

FIG. 2A is a perspective diagram of an ink cartridge according to an embodiment of the invention with a portion of a side wall and bottom wall removed to illustrate internal features.

FIG. 2B is a perspective diagram of the under side of the ink cartridge of FIG. 2A.

FIG. 3A is a perspective diagram of the cover for sealing the ink chamber with an elongate tube extending therefrom.

FIG. 3B is a diagram of the top of the cover of FIG. 3A.

FIG. 3C is a diagram showing a cross section taken through the line A-A in FIG. 3B.

FIG. 3D is a diagram of the cover of FIG. 3A viewed from the front.

FIG. 3E is a diagram of the cover of FIG. 3A viewed from the side.

FIG. 3F is a diagram of the cover of FIG. 3A viewed from the back.

FIG. 3G is a diagram of the cover of FIG. 3A viewed from underneath.

FIG. 4 is a diagram of a tube extending from a cover with a valve being associated with the opening at the lower end of the tube. FIG. 5A is a perspective diagram of an ink cartridge according to another embodiment of the invention with a portion of a side wall and bottom wall removed to illustrate internal features.

FIG. 5B is a perspective diagram of the under side of the ink cartridge of FIG. 5A.

FIG. 6A is a perspective diagram of an ink cartridge according to yet another embodiment of the invention with a portion of a side wall and bottom wall removed to illustrate internal features.

FIG. 6B is a perspective diagram of the under side of the ink cartridge of FIG. 6A.

FIG. 7A is a diagram of a side view of an ink cartridge in use according to an embodiment of the present invention.

FIG. 7B is a diagram of a side view of the ink cartridge in FIG. 7A.

FIG. 7C is a diagram of a side view of the ink cartridge FIG. 7A.

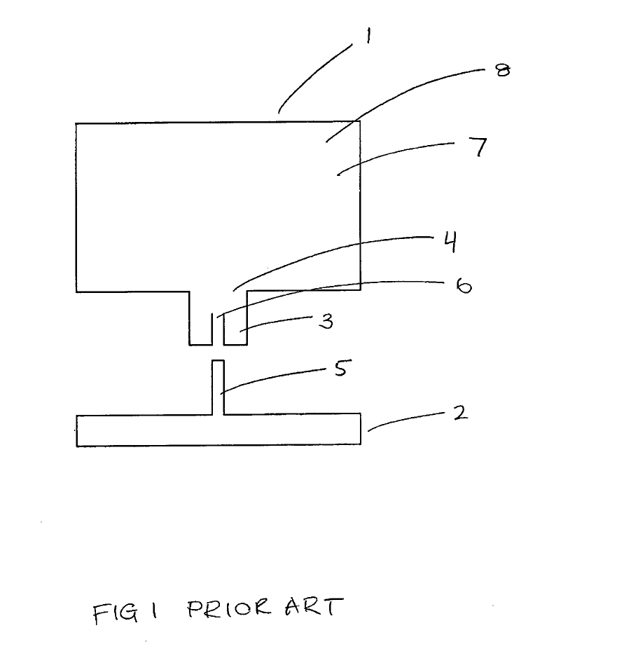

### DETAILED DESCRIPTION OF THE EMBODIMENT

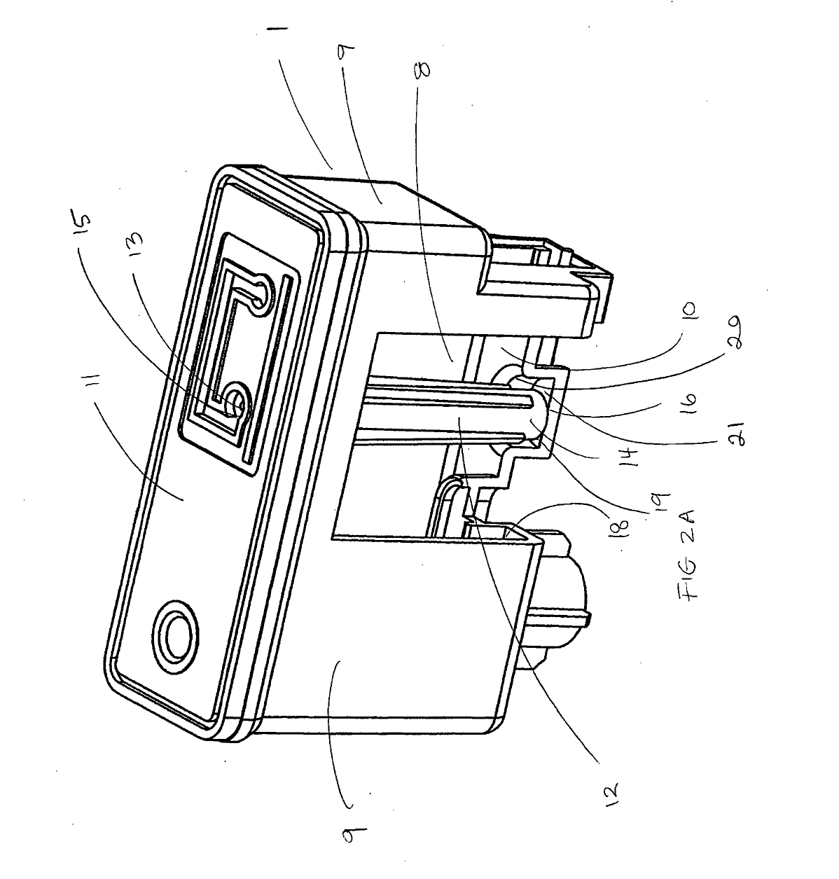

FIG. 2A illustrates a refillable ink cartridge 1 suitable for removable connection to a print head 2 for an inkjet printer. The ink cartridge 1 comprises at least one ink chamber 8 comprising side walls 9 and a bottom wall 10. Each ink chamber 8 is hermetically sealed by a cover 11 which forms a top wall for the ink chamber 8. Typically, the cover 11 is sealed to the side walls 9 using any suitable welding or heat sealing method.

A tube 12 extends from the cover 11 into the ink chamber 8. The tube 12 comprises a continuous opening extending from an upper 13 to a lower end 14 of the tube 12. The tube 12 is preferably elongate and cylindrical in shape but may be another suitable shape. The aperture 15 in the upper end 13 of the tube 12 passes through the cover 11 to which the tube 12 is attached to form an aperture 15 therein. The tube 12 provides contact with the ambient atmosphere in an otherwise hermetically sealed environment within the ink chamber 8. The opening 16 at the lower end 14 of the tube 12 is provided with a valve 17, enabling the opening 16 to be opened and closed to controllably admit air into the ink chamber 8. The ink cartridge 1 further has an ink supply port 18 through which ink 7 is supplied to the print head 2 via an ink supply needle 5.

Sealing and unsealing of the tube 12 by the valve 17 occurs in response to variations in the negative pressure within the ink chamber 8. The negative pressure within the ink chamber 8 must be maintained at an operational level. The level of negative pressure is operational when the pressure level negative pressure is sufficiently low to maintain a flow of ink 7 from to the ink supply needle 5 as required whilst being sufficiently high to prevent any unwarranted leaking of the ink 7.

In a preferred embodiment of the present invention, the valve 17 comprises a movable portion and a fixed portion. More preferably, the valve 17 is welded or otherwise heat sealably adhered to approximately one third of the rim 19 of the opening 16 of the tube 12. Even more preferably, the valve 17 comprises a flexible material such as a resiliently flexible film.

The valve 17 opens and closes by flexing the movable portion of the valve in response to pressure variations within the tube 12. The tube 12 is sealed in response to a high negative pressure within the ink chamber 8, that is when the pressure inside the ink chamber 8 exceeds the pressure within the tube 12, by flexing the movable portion of the valve 17 against the rim 19 of the opening 16 of the tube 12. If the pressure within the ink chamber 8 drops lower than the negative pressure within the tube 12, the valve 17 opens to admit air by flexing the movable portion of the valve 17 away from the rim 19 of the opening 16 of the tube 12.

FIG. 2A illustrates a preferred embodiment of the invention wherein the tube 12 extends into a well 20 positioned in the bottom wall 10 of the ink chamber 8. By positioning the opening 16 of the lower end 14 of the tube 12 in a well 20 whose bottom 21 lies below the level of the bottom wall 10 of the ink chamber 8, the opening 16 in the lower end 14 of the tube 12 will remain constantly submerged below ink 7, even when the ink 7 level is low.

FIG. 2B illustrates more clearly the relative position of the well 20 in the bottom wall 10 of the ink chamber 8 for receiving the lower end 14 of the tube 12 and the ink supply port 18. The ink supply port 18 provides the outlet through which ink 7 is supplied from the ink chamber 8 to the print head 2 through the ink supply needle 5.

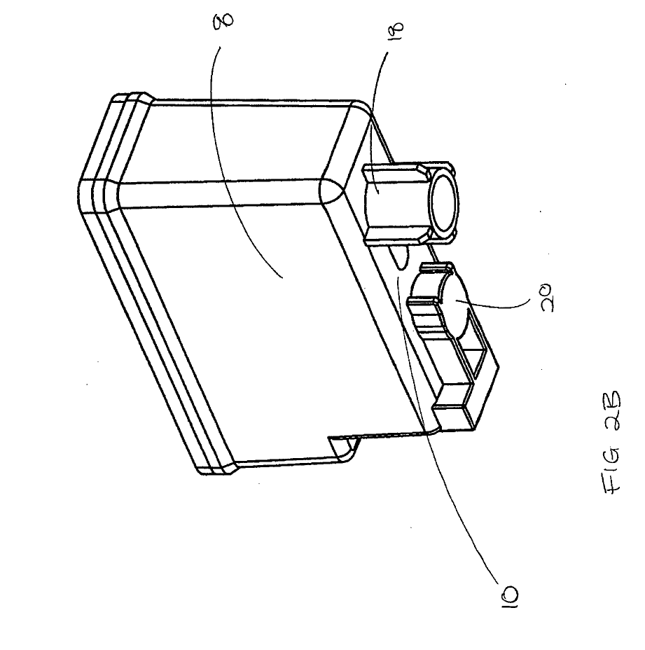

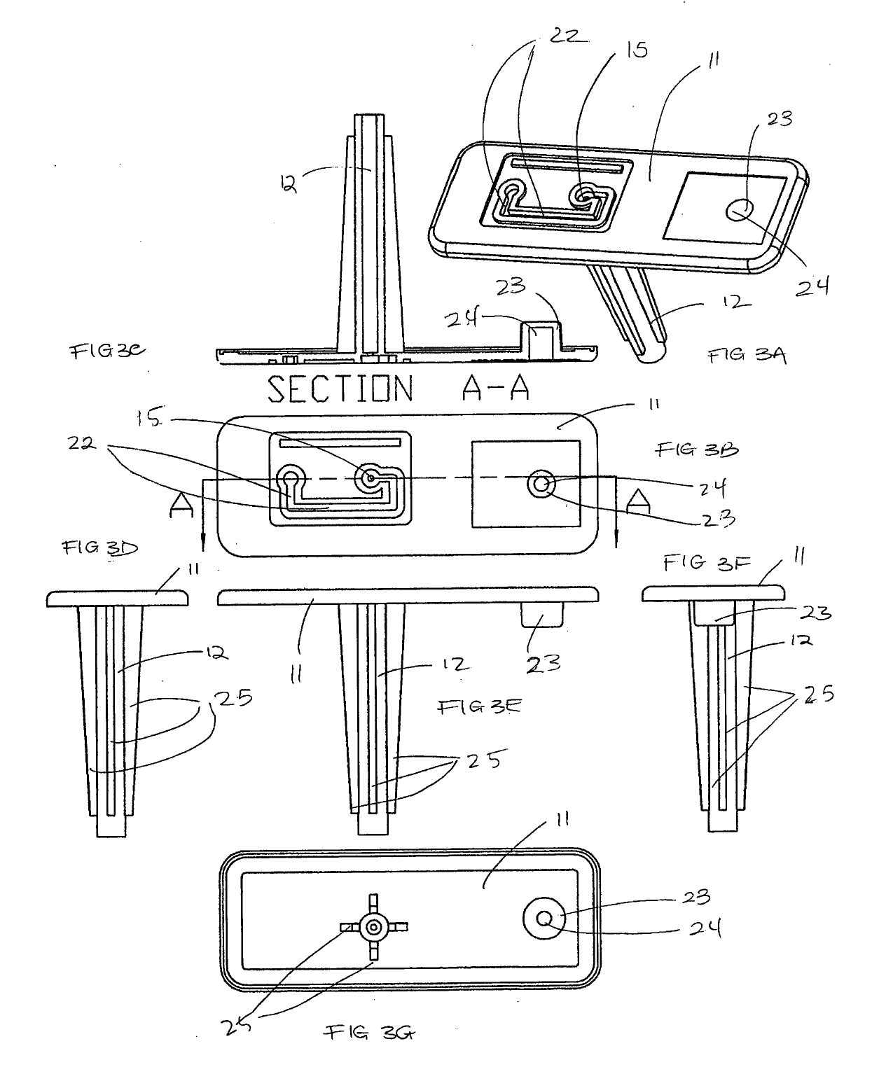

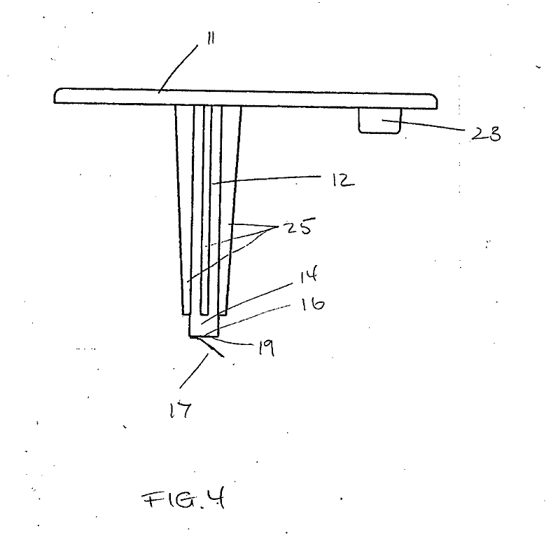

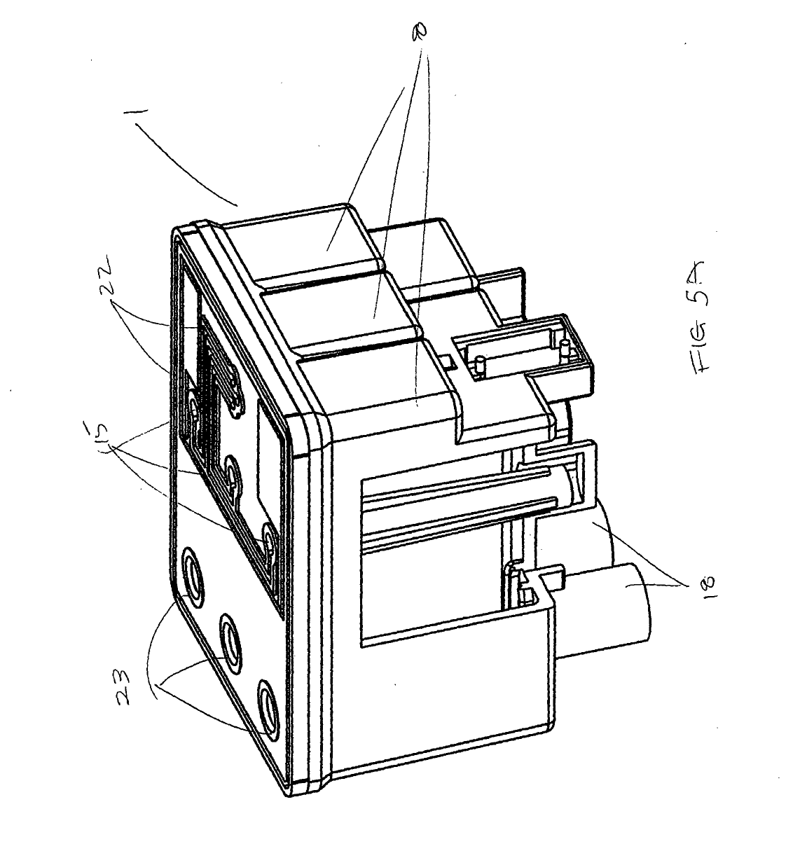

FIG. 3A illustrates a top perspective of the cover 11 which hermetically seals the ink chamber 8 by forming a top wall therefore. The external surface of the cover 11 exhibits a number of features including an aperture 15 which forms the opening in the upper end 13 of the elongate tube 12 which extends from the cover 11 into the ink chamber 8. A series of interconnected grooves 22 may be associated with each aperture 15. By permitting the exchange of air to occur through the interconnected grooves 22 only, such as by affixing a tape to overlie the rims of the grooves leading to the aperture 15 but exposing the other end of the grooves to the ambient air, there is a lower likelihood of losing ink 7 to evaporation.

Furthermore, an ink injection port 23 is provided in the cover 11. The ink injection port 23 is hermetically sealed with a resilient plug 24. The ink injection port 23 is employed in the filling and refilling of the ink chamber 8 with ink 7.

Filling of the ink chamber 8 with ink 7 occurs by inserting a needle associated with a suitable ink injection apparatus. In order to establish the appropriate operational negative pressure within the ink chamber 8, it is necessary to firstly evacuate the ink chamber 8 to create a vacuum, before preceding to inject ink 7 into the ink chamber 8 to the appropriate level via a needle inserted into a resilient plug 24 sealing the ink injection port 23.

FIG. 3B represents the cover 11 previously described as viewed from directly above.

FIG. 3C represents the cross section taken through the line A-A in FIG. 3B. In this figure, the arrangement of the elongate tube 12 and the ink injection port 23 may be observed more clearly.

FIG. 3D illustrates the cover 11 shown previously in FIG. 3A from the front with the tube 12 extending vertically downwards from the cover 11. In the embodiment shown, the tube 12 includes four reinforcing ribs 25 running along its length in order to strengthen the tube 12.

FIG. 3E illustrates the cover 11 of FIG. 3A shown from the side. The recess for the ink injection port 23 can be observed on relation to the elongate tube 12.

FIG. 3F illustrates the cover 11 of FIG. 3A shown from the back.

FIG. 3G represents the cover 11 shown in FIG. 3A as viewed from underneath. The configuration of the elongate tube 12 as provided with four reinforcing ribs 25 running along the length of the tube 12 can be clearly seen. It is to be understood that the elongate tube 12 could be supported by any suitable number of reinforcing ribs 25.

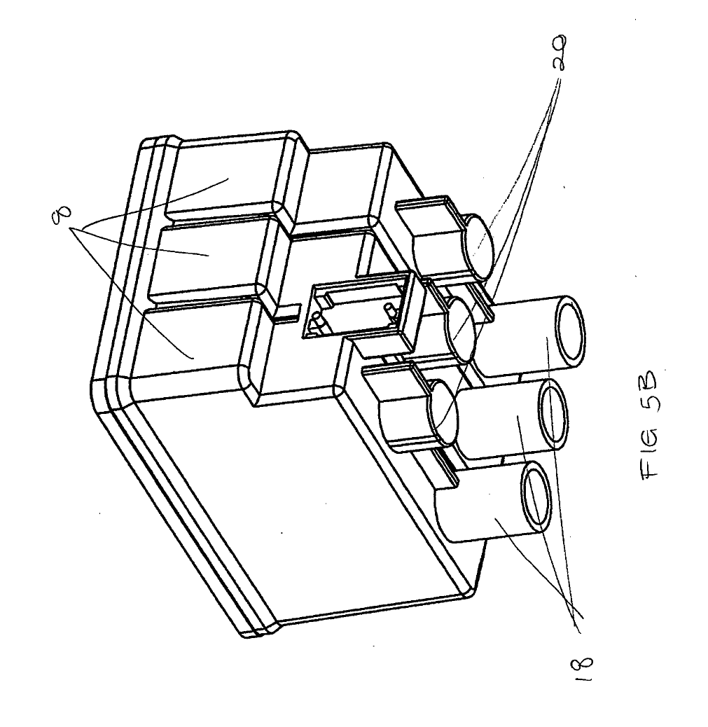

FIG. 4 illustrates a tube 12 extending from a cover 11 used to seal an ink chamber 8, the tube 12 having a valve 17 associated with the opening 16 at the lower end 14. The valve 17 comprises a suitable flexible material which is preferably a resiliently flexible film. The valve 17 includes a fixed portion which is welded to the rim 19 of the opening 16 of the lower end 14 of the tube 12. Most preferably, the valve 17 is welded to otherwise heat sealably adhered to approximately one third of the rim 19 of the opening 16 of the tube 12. The tube 12 further includes a movable portion which is free to move towards the opening 16 or away from the opening 16 to open and close the same.

It should be apparent that the invention as described is applicable to more than just ink cartridges 1 having a single ink chamber 8 for supplying black ink 7 to a printer. The same principles apply for ink cartridges 1 having multiple ink chambers 8 for supplying ink 7 to a coloured printer.

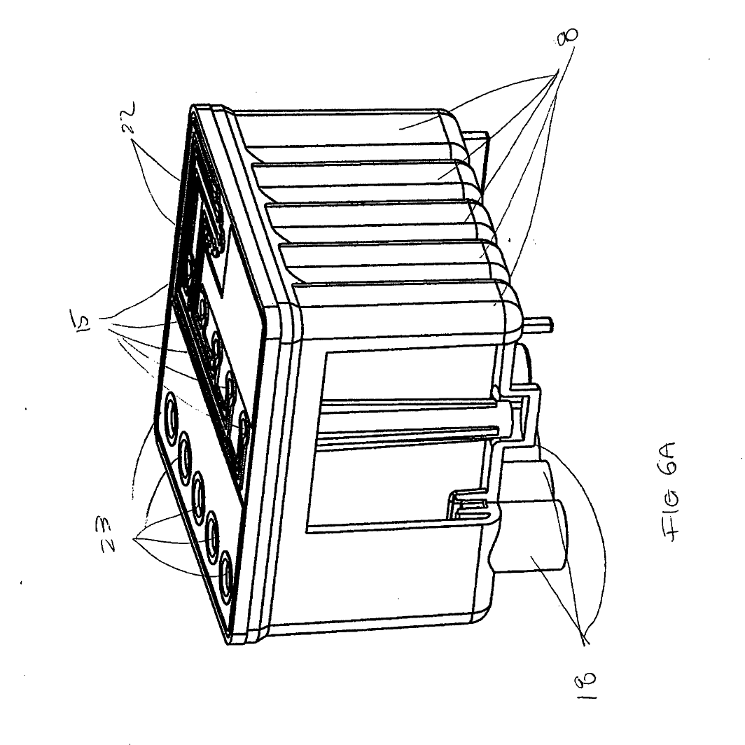

FIG. 5A illustrates an ink cartridge 1 having three ink chambers 8. Such ink cartridges 1 are suitable for providing ink 7 to a coloured printer. In this case each of the ink chambers 8 will contain a different colour ink 7, e.g. cyan, magenta and yellow.

Each of the three ink chambers 8 has its own ink supply port 18, ink injection port 23 and elongate tube 12 extending from the cover 11 to provide for the inlet of air. Each ink chamber 8 must be provided with a dedicated tube 12 and inlet and outlet ports in order to prevent contamination of ink 7.

FIG. 5B illustrates the ink cartridge 1 of FIG. 5A viewed from another perspective. When viewed from underneath in this manner, it can be seen that each individual ink chamber 8 is provided with an individual ink supply port 18 and a well 20 for receiving the elongate tube 12 which extends from the cover 11 to provide for the inlet of air.

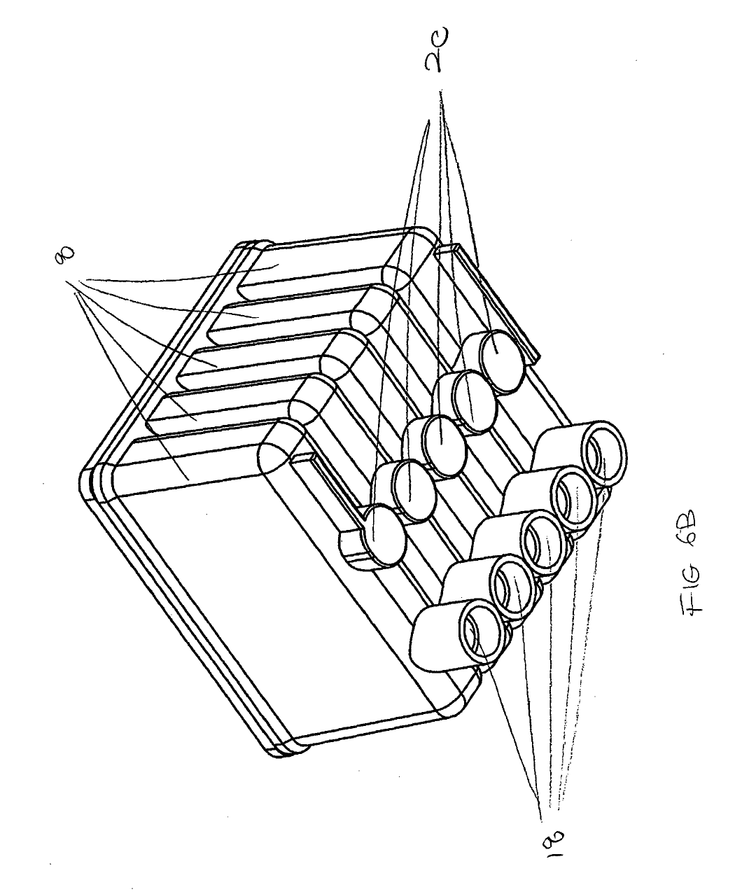

FIG. 6A represents an ink cartridge 1 having five ink chambers 8.

FIG. 6B illustrates the under side of the ink cartridge 1 of FIG. 6A.

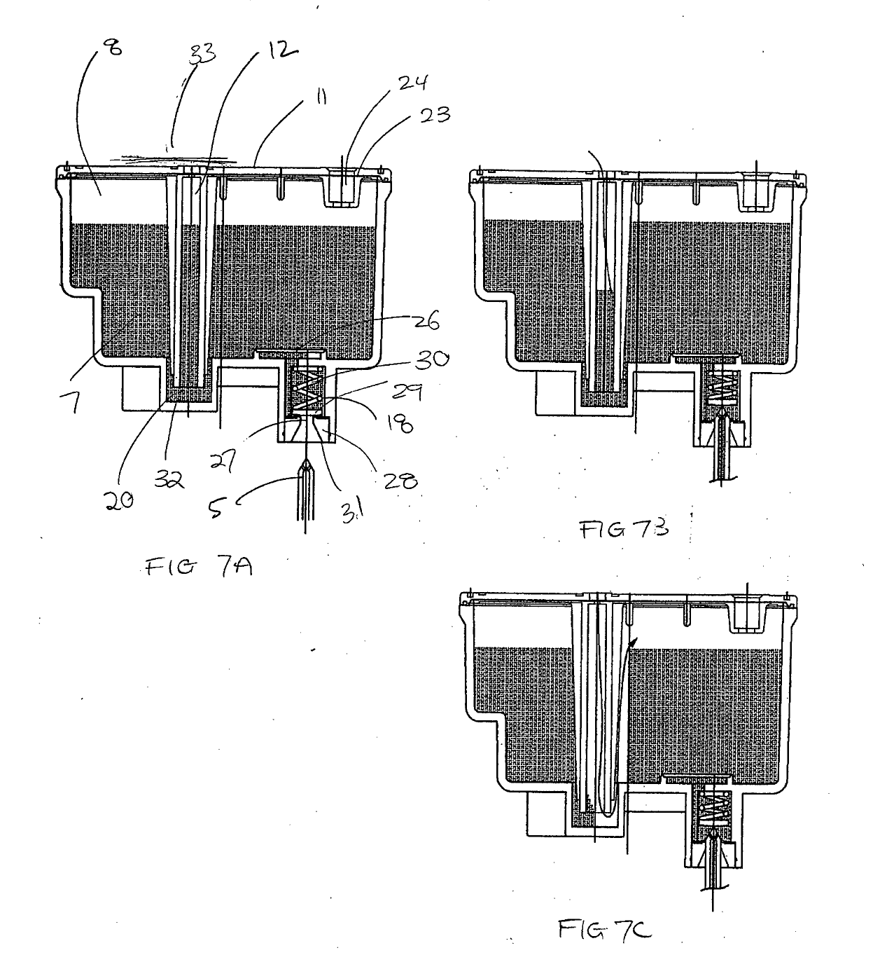

FIG. 7A illustrates a cross section of an ink cartridge 1 of the present invention filled with ink 7 as viewed from the side. The ink cartridge 1 comprises an ink chamber 8 for storing ink and a cover 11 to hermetically seal the ink chamber 8 to prevent the drying out and contamination of ink 7. The cover 11 preferably contains two apertures 15,23. The first aperture 15 forms the opening in the upper end 13 of the elongate tube 12 extending from the cover 11 into a well 20 having a bottom 21 at a level below the bottom wall 10 of the ink chamber 8, to provide for the equalization of pressure within the ink chamber 8. The opening 16 at the lower end 14 of the tube 12 must be associated with a valve 17 which can regulate the admission of air from the ambient atmosphere. Any influx of air has the effect of causing bubbles of air to form within the ink 7 which surface to increase the negative pressure within the ink chamber 8. Increasing the negative pressure within the ink chamber 8 causes the surface tension of the ink 7 to increase thereby allowing the ink 7 to form a liquid seal within the ink supply port 18 and to maintain the same to prevent a leakage of ink 7 therefrom. The discharge of ink 7 from the ink chamber 8 causes the negative pressure within the ink chamber 8 to increase. Negative pressure may also vary in response to external factors including variations in temperature or altitude and the like. The valve 17 provided to seal the opening 16 at the lower end 14 of the elongate tube 12 will open and close the tube 12 in response to fluctuations in negative pressure within the ink chamber 8 to regulate the same at maintain the negative pressure at operational levels.

Furthermore the illustration shows the ink supply port 18 through which ink 7 is supplied to the print head 2 via an ink supply needle 5. A filter 26 is fitted above the ink supply port 18 to filter 26 any grit or debris from the ink 7 to prevent clogging of the ink supply needle 5. The ink supply port 18 has an aperture 27 for receiving the ink supply needle 5. As in many conventional ink cartridges 1, this may be achieved by fitting the ink supply port 18 with a resilient plug 28 containing an aperture 27 adapted to receive the ink supply needle 5. In addition there is provided a stopper 29 for sealing the ink supply port 18.

FIG. 7B illustrates the operation of the stopper 29 to seal the ink supply port 18. When the ink supply needle 5 is inserted through the aperture 27 in the ink supply port 18, the stopper 29 is moved away from the aperture 27, thereby opening the ink supply port 18. Referring back to FIG. 6A it may be observed that when the ink supply needle 5 is withdrawn from the aperture 27 the stopper 29 covers the aperture 27, thereby closing the ink supply port 18. Preferably, the stopper 29 is resiliently biased towards sealing the aperture 27. In the illustrated embodiment, the resilient biasing occurs by means of a compression spring 30. In a most preferred embodiment of the present invention, the compression spring 30 is formed from polyoxymethylene.

FIG. 7C further illustrates the operation of the ink cartridge 1 of FIG. 7A in demonstrating how an influx of air occurs as ink 7 is discharged.

Finally, there is provided by the present invention, a method of assembling a refillable ink cartridge 1. The ink cartridge 1 is configured generally as described in the preceding description and includes an ink chamber 8 having side walls 9 and a bottom wall 10 which includes an ink supply port 18. The assembly involves welding of a filter 26 to an upper portion of the ink supply port 18 and installation of a stopper 29 in the ink supply port 18. The ink supply port 18 may then be sealed with a deformable film 31 for shipping and handling purposes. It is to be understood that after first use and upon refilling the deformable film 31 will no longer be substantially present. A flexible film 32 is attached to a portion of the opening 16 at the lower end 14 of an elongate tube 12, the tube 12 extending into the ink chamber 8 from a cover 11 forming a top wall of the ink chamber 8, such that the film may function as a valve 17 to regulate the entry of ambient air into the ink chamber 8. The ink injection port 23 is sealed with a resilient plug 24. The cover 11 is welded to the ink chamber 8 to hermetically seal the ink chamber 8 by forming a top wall. Any suitable welding or heat sealing method may be used, such as for example ultrasonic welding. Tape 33 is adhered to an external surface of the cover 11 to seal the apertures 15,23 therein when the ink cartridge is not in use including for storage and handling purposes. This is to prevent the drying out or evaporation of ink 7 whilst the cartridge is not in use. Furthermore, in order to achieve the appropriate operational negative pressure within the ink chamber 8, it is necessary to evacuate the ink chamber 8 via a needle inserted through the plug 24 sealing the ink injection port 23. Once a vacuum has been created in the ink chamber 8, ink 7 may be supplied to the ink chamber 8 via a needle inserted through plug 24 in the ink injection port 23.

Whilst some embodiments of the present invention have been illustrated here in detail, it should be apparent that modifications and adaptations to these embodiments may occur to one skilled in the art without departing from the scope of the invention set forth in the following claims.

1. A refillable ink cartridge for removable connection to a print head, the ink cartridge comprising:
(a) at least one ink chamber comprising side walls and a bottom wall;
(b) a cover hermetically sealing the ink chamber or chambers by forming a top wall therefor;
(c) a tube associated with each ink chamber, the tube extending from the cover into the ink chamber and comprising a continuous opening extending from an upper to a lower end of the tube;
(d) a valve associated with the opening at the lower end of the tube to enable the opening to be opened and closed to controllably admit air into the ink chamber; and
(e) an ink supply port through which ink is supplied to the print head via an ink supply needle.

2. A refillable ink cartridge according to claim 1, wherein an operational negative pressure within the ink chamber is regulated by the valve so that the operational negative pressure is sufficiently low to maintain a flow of ink from to the ink supply needle as required whilst being sufficiently high to prevent seepage of ink therefrom.

3. A refillable ink cartridge according to claim 1, wherein the tube associated with each ink chamber is an elongate tube.

4. A refillable ink cartridge according to claim 3, wherein the elongate tube further comprises more than one reinforcing rib running along its length.

5. A refillable ink cartridge according to claim 1, wherein the lower end of the tube extends into a well positioned in the bottom wall of the ink chamber.

6. A refillable ink cartridge according to claim 1, wherein the valve comprises a movable portion and a fixed portion.

7. A refillable ink cartridge according to claim 1, wherein the valve comprises a resiliently deformable material which deforms to admit air from the tube into the ink chamber when the pressure in the tube sufficiently exceeds the pressure in the ink chamber.

8. A refillable ink cartridge for removable connection to a print head via an ink supply needle, the ink cartridge comprising:
(a) at least one ink chamber;
(b) a cover hermetically sealing the ink chamber or chambers;
(c) an ink supply port having an aperture for receiving the ink supply needle; and
(d) a stopper for the ink supply port;
wherein when the ink supply needle is inserted through the aperture in the ink supply port, the stopper is moved away from the aperture, thereby opening the ink supply port and when the ink supply needle is withdrawn from the aperture the stopper covers the aperture, thereby closing the ink supply port.

9. A refillable ink cartridge according to claim 8, wherein the stopper is resiliently biased towards opening the aperture.

10. A refillable ink cartridge according to claim 9, wherein the resilient biasing occurs by means of a compression spring.

11. A refillable ink cartridge according to claim 10, wherein the compression spring is formed from polyoxymethylene.

12. A method of assembling a refillable ink cartridge, the ink cartridge including an ink chamber having side walls and a bottom wall which includes an ink supply port, the method comprising:
(a) welding a filter to an upper portion of the ink supply port;
(b) installing a stopper in the ink supply port;
(c) sealing the ink supply port with a deformable film;
(d) attaching a flexible film to a portion of the lower opening of a tube, the tube extending into the ink chamber from a cover forming a top wall of the ink chamber;
(e) sealing an ink injection port positioned within the cover with a resilient plug;
(f) welding of the cover to the ink chamber to form the top wall;
(g) adhering a tape to an external surface of the cover to seal apertures therein;
(g) evacuation of the ink chamber via a needle inserted through the plug sealing the ink injection port; and
(h) supply of ink to the ink chamber via a needle inserted through plug in the ink injection port.
